(19) United States
(12) Patent Application Publication
(10) Pub. No.: US 2020/0066016 A1
(43) Pub. Date: Feb. 27, 2020

(54) System For Editing Monitor Script In Screen Image And Method Thereof

(71) Applicants: Inventec (Pudong) Technology Corporation, Shanghai (CN); Inventec Corporation, Taipei City (TW)

(72) Inventor: Lei Wang, Shanghai (CN)

(21) Appl. No.: 16/226,354

(22) Filed: Dec. 19, 2018

(30) Foreign Application Priority Data
Aug. 24, 2018 (CN) 201810972325.4

(51) Int. Cl. G06T 11/60; G06F 17/24; G06F 17/21; G06T 7/73

(52) U.S. Cl. CPC G06T 11/60; G06F 17/24; G06T 2207/20104; G06T 7/74; G06F 17/214

(57) ABSTRACT

A system for editing a monitor script in a screen image and a method thereof are provided. By capturing a screen image from a display screen of a device to be monitored, determining location data of a target area and a front attribute of text displayed on the target area after providing the screen image for selecting the target area and selecting the target area from the screen image, and generating a monitor command included in a monitor script according to the location data and the front attribute, the system and the method can reduce the difficulty of editing the monitor script, and the effect of editing the monitor script in a more intuitive way can be achieved.

### BACKGROUND OF THE INVENTION

1. Field of the Invention

The present invention generally relates to a script editing system and a method thereof, more particularly to a system for editing a monitor script in a screen image and a method thereof.

2, Description of the Related Art

The production line continues to operate. Once the device that maintains the operation of the production line fails, the production line will stop, which will cause huge losses. Therefore, there is usually a monitoring system for the device that maintains the operation of the production line, so that the abnormal device can be found in advance before the production line is stopped due to the failure of the device that maintains the operation of the production line, and the person is notified to repair the abnormal device.

The current schemes of the monitoring system for monitoring device mainly include intrusive and non-intrusive schemes to obtain data of the monitored device. The monitoring system usually uses the intrusive scheme to obtain the data of the device to monitor the device. However, the intrusive scheme is often not available on the older device or on device with very strict safety control. Therefore, there are also some non-invasive schemes in the industry.

Currently, the non-intrusive monitoring scheme requires the establishment and maintenance of the monitoring script, and the monitoring script is executed by a specific device to monitor the monitored device. In addition, the current non-intrusive monitoring scheme also requires that the window displayed by the monitored device cannot be moved after the monitoring script is established. Once the window is displaced, it is necessary to re-acquire the coordinates and range of the area to be monitored, and modify the script commands corresponding thereto.

However, script commands are like program codes. Each command consists of several letters and symbols. Editing a script command may require additional tools to obtain the coordinates and range of the area to be monitored. In addition to learning the syntax of script commands, users also need to learn the tools for obtaining coordinates and range, and even need to find script commands that need to modify coordinates in complex monitoring scripts. Therefore, it is not easy to edit the script commands for the general user. Even if only the coordinates of the area to be monitored need to be slightly adjusted because of the displacement of the window, the technician needs to be asked to adjust it, and the general user cannot adjust it by himself.

In summary, it can be seen that in the prior art there is a problem that there is a certain degree of difficulty in editing script commands that can only be done by professionals, and therefore it is necessary to propose an improved technical means to solve this problem.

### SUMMARY OF THE INVENTION

In order to solve the conventional problems that there is a certain degree of difficulty in editing script commands that can only be done by professionals, the present invention provides a system for editing a monitor script in a screen image and a method thereof.

According to an embodiment, the present invention provides a system for editing a monitor script in a screen image. The system comprises an image capturing module, an area selecting module, an attribute determination module, a parameter setting module, and a script generation module. The image capturing module is configured to capture the screen image from a display screen. The area selecting module is configured to display the screen image, provide the screen image for selecting a target area, and select the target area. The attribute determination module is configured to determine location data of the target area and determine a font attribute of text displayed in the target area. The parameter setting module is configured to provide an output parameter for setting, and set the output parameter. The script generation module is configured to generate a monitoring command according to the font attribute and the location data, generate an output command according to the output parameter, and generate the monitoring script including the monitoring command and the output command.

According to an embodiment, the present invention provides a method for editing a monitor script in a screen image. The method comprises steps of: capturing the screen image from a display screen; displaying the screen image, providing the screen image for selecting a target area; and selecting the target area; determining location data of the target area; determining a font attribute of text displayed in the target area; generating a monitor command according to the location data and the font attribute of the text; providing an output parameter for setting, setting the output parameter, and generating an output command according to the output parameter; and generating the monitor script including the monitor command and the output command.

According to above contents, the difference between the conventional technology and the system and method of the present invention is that capturing the screen image from the display screen of the device to be monitored; determining location data of the target area and the front attribute of text displayed on the target area after providing the screen image for selecting the target area; generating the monitor command included in the monitor script according to the location data and the front attribute; and providing the output parameter for setting, and generating the output command included in the monitor script according to the output parameter, so that the problem in the prior art is solved, and the technical effect of editing the script commands in a more intuitive manner is achieved.

### BRIEF DESCRIPTION OF THE DRAWINGS

The structure; operating principle and effects of the present invention will be described in detail by way of various embodiments which are illustrated in the accompanying drawings.

FIG. 1 is an architecture diagram of a system for editing a monitor script in a screen image according to the present invention.

FIG. 2 is a flowchart of a method for editing a monitor script in a screen image, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

As used herein, the term “or” includes any and all combinations of one or more of the associated listed items. It will be understood that when an element is referred to as being “on,” “connected to” or “coupled to” another element, it can be directly on, connected or coupled to the other element, or intervening elements may be present. In contrast, when an element is referred to as being “directly on,” “directly connected to” or “directly coupled to” another element, there are no intervening elements present.

In addition, unless explicitly described to the contrary, the word “comprise” and variations such as “comprises” or “comprising”, will be understood to imply the inclusion of stated elements but not the exclusion of any other elements.

The present invention can provide a user to edit a script by setting a script command through a screen image displayed in a window interface.

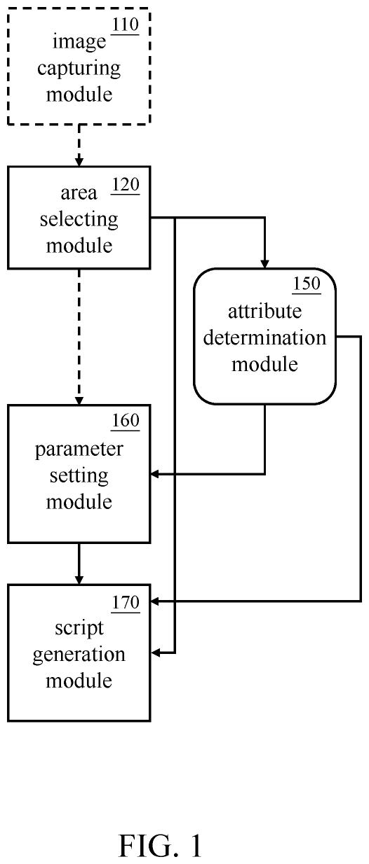

The operation of a system for editing a monitor script in a screen image of the present invention is described below with reference to FIG. 1. As shown in FIG. 1, the system of the present invention comprises an area selecting module 120, an attribute determination module 150, a parameter setting module 160, a script generation module 170, and an image capturing module 110 that can be attached are included.

The image capturing module 110 can capture a screen image from a display screen (not shown in the figure) of a target device to be monitored. Generally, the screen image captured by the image capturing module 110 contains everything in the display screen. The display screen is a screen displayed by a display module of the target device such as a screen of the target device.

The area selecting module 120 is configured to display the screen image. The screen image displayed by the area selecting module 120 contains everything in the display screen when the display screen of the target device is captured. The screen image may be captured by the image capturing module 110, or may be captured by an external device or module. For example, the target device to be monitored captures the screen image, and the present invention is not particularly limited.

The area selecting module 120 is also configured to provide the screen image displayed for selecting a target area, and select the target area. The area selecting module 120 can provide the method that directly inputting the coordinates in the display screen or screen image to select the target area, or can provide the method of clicking and drag-and-drop to frame the target area in the screen image displayed, or can provide the method that double-clicking and enclosing the double-clicked position in the screen image to select the target area, but the present invention is not limited thereto, and any manner in which the user can select the target area in the screen image can be used in the present invention.

In some embodiments, the area selecting module 120 may also provide the screen image captured by the image capturing module 110 for selecting a monitoring range (not shown in the figure), and select the target area. The area selecting module 120 can uses the same or similar manner as selecting the target area to select the monitoring range in the screen image.

The area selecting module 120 may also analyze the selected monitoring range, thereby determining one or more target areas in the monitoring range. For example, the area selecting module 120 can determine the target areas according to the color blocks and/or lines in the screen image based on the monitoring range. In more detail, the area selecting module 120 can determine different color blocks in the monitoring range as different target areas, determine the portions separated by the lines in the monitoring range as different target areas, etc. The manner in which the area selecting module 120 determines the target areas from the monitoring range is not limited to the above. For example, the area selecting module 120 can also determine the target areas in the monitoring range according to the control element or other objects in the monitoring range.

The area selecting module 120 may also generate target representation data corresponding to the target area. In general, the area selecting module 120 may randomly generate the target representation data or generate the target representation data according to predetermined rules, and the present invention is not particularly limited. The target representation data of the present invention can be arbitrarily arranged by any number of characters, letters, numbers and symbols to represent the target area corresponding thereto.

The area selecting module 120 is also configured to obtain the location data of the selected target area. The location data of the present invention may indicate a location of a specific area such as the target area in the display screen or the screen image; for instance coordinates of an upper right corner and a lower left corner of a specific area, a coordinate of a lower right corner of a specific area and the width and height of the specific area, etc., but the invention is not limited to the above.

In some embodiments, the area selecting module 120 may determine the relative positions of the index coordinate point and the reference coordinate point to generate location data. At this time, the location data may be a relative distance from the reference coordinate point to the index coordinate point, and the width and height of the target area, but the invention is not limited thereto. The index coordinate point is a coordinate of a specific point on the target area in the screen image. The reference coordinate point is a coordinate of a specific point in the display screen or the screen image. The specific points mentioned above include but are not limited to the upper left corner, the lower left corner, the upper right corner, the lower right corner, or the center point. In general, the relative position of the index coordinate point on the target area coincides with the relative position of the reference coordinate point in the screen image or the display screen. For example, when the index coordinate point is the coordinate of the upper left corner of the target area, the reference coordinate point is also the coordinate of the upper left corner of the display screen or the screen image.

The area selecting module 120 may also mark a target area corresponding thereto in the screen image displayed according to the location data of the target area, and provide a range covered by the target area adjusted, and at the same time, the area selecting mode 120 can also obtain the location data of the adjusted target area. For example, the area selecting module 120 may use lines to frame a target area in the screen image and provide the range covered by the target area adjusted by moving displayed lines, but the method in which the area selecting module 120 provides a range covered by the adjusted target area is not limited to the above.

The attribute determination module 150 is configured to determine the font attribute of the text in the target area selected by the area selecting module 120. The font attribute determined by the attribute determination module 150 includes, but is not limited to, a character style (font), a font size, whether it is bold, whether it is italic, whether there is a bottom line, whether there is a strikethrough, and the like. Since the operating system must display the characters in the target area using the installed font, and the font attributes of the same text displayed by the operating system are the same, the styles and features of the text displayed in the display screen are fixed. Therefore, the attribute determination module 150 can determine various font attributes such as the font and font size of the text displayed in the target area by different font sizes of the fonts already installed in the operating system.

In general, the attribute determination module 150 can extract the target image covered by the target area from the screen image captured by the image capturing module 110 according to the location data of the target area obtained by the area selecting module 120, and compare the captured target image with the fonts installed in the operating system. When the text represented in the target image is the same as the template (or feature) of the compared font, or the similarity reaches the threshold value, the attribute determination module 150 can determine that the characters in the target area use the compared font, and thereby determine other font attributes of the text in the target area. However, the manner in which the attribute determination module 150 determines the font attributes of the text in the target area is not limited to the above.

The attribute determination module 150 may first compare the captured target image with one or more common fonts, and then compares the selected fonts that are not in the common fonts installed in the operating system with the captured target image when the font attribute of the text in the target area selected by the area selection module 120 cannot be determined by the common fonts (that is, fonts that match the text represented by the target image cannot be found in common fonts), so as to determine the font attribute of the text in the target area.

The common fonts of the present invention may be defined by the operating system, may be defined by a specific external application, or may be defined by the attribute determination module 150, and the present invention is not particularly limited. For example, the attribute determination module 150 may accumulate the number of times the font is determined when whenever the font attribute is determined, and may define the font whose cumulative number of times reaches the threshold value as a common font, or may define a number of fonts with a higher cumulative number of times as common fonts. The attribute determination module 150 can also define fonts included in the font attributes determined in the previous several times as common fonts.

The attribute determination module 150 may also display the determined font attributes. For example, the attribute determination module 150 may display the determined font attributes in a position separated by a certain distance from the target area selected by the area selecting module 120 in the screen image displayed by the area selecting module 120. The attribute determination module 150 can display the font attribute by using a pop-up dialog box. However, the manner in which the attribute determination module 150 displays the font attributes is not limited to the above.

The attribute determination module 150 may also provide the determined font attribute for editing. For example, the attribute determination module 150 may provide the drop-down menu in the displayed dialog box for selecting the font and font size of the text in the target area, or may provide checkboxes in the dialog box for selecting whether the text in the target area is bold, whether the text in the target area is underlined, or whether the text in the target area has a strikethrough. The attribute determination module 150 can also change the font attribute of the text in the target area to the edited font attribute. However, the manner in which the attribute determination module 150 edit the determined font attribute is not limited to the above.

The attribute determination module 150 may also provide the target representation data corresponding to the target area for editing. For example, the attribute determination module 150 can provide an input field in the dialog box displayed for editing target representation data. For example, the user can use his own understood method to edit the target representation data corresponding to the target area, but the invention is not limited thereto.

The parameter setting module 160 is configured to provide execution environment data for setting, and set the execution environment data. The execution environment data provided by the parameter setting module 160 for setting may be one or more output parameters, or may be a monitoring mode, or may be an execution frequency of the monitoring script. In general, the parameter setting module 160 can provide execution environment data for setting such as output parameters, monitoring mode, and execution frequency by using a dialog box or a page tab, and set the execution environment data.

The output parameter includes an output item corresponding to the target area selected by the area selecting module 120. That is, the parameter setting module 160 can provide the target areas selected by the area selecting module 120 for selecting, select the target area, and obtain the target representation data corresponding to the selected target area, whereby the obtained target representation data is used as the output item.

The parameter setting module 160 provides the monitoring mode for setting to indicate that the local device that executes the monitoring script is monitored, or that the specific remote device is monitored through the network. When the monitoring mode indicates that the remote device is monitored, the parameter setting mode module 160 can also provide a network address of the remote device for setting.

The parameter setting module 160 provides the execution frequency for setting, which may be performed only once, or may indicate that the continuous execution is not stopped. When the execution frequency indicates no stop, the parameter setting module 160 may also provide an interval for each execution time.

The script generation module 170 is configured to generate a monitoring command according to the font attribute determined by the attribute determination module 150 and the location data obtained by the area selecting module 120, and is also configured to generate a output command according to the output parameter set by the parameter setting module 160. The monitoring command may enable the device that executes the monitoring script to identify the text in the target area, and the output command may output the identification result of the text in the target area.

The script generation module 170 may also generate an environment command according to the monitoring mode set by the parameter setting module 160, or may generate another environment command according to the execution frequency set by the parameter setting module 160.

The script generation module 170 is also configured to generate the monitoring script. The monitoring script generated by the script generation module 170 comprises the monitoring command and the output command. If the script generation module 170 also generates the environment command, the monitoring script generated by the script generation module 170 may also comprise the environmental command. That is to say, the monitoring script generated by the script generation module 170 may comprise various commands generated by the script generation module 170.

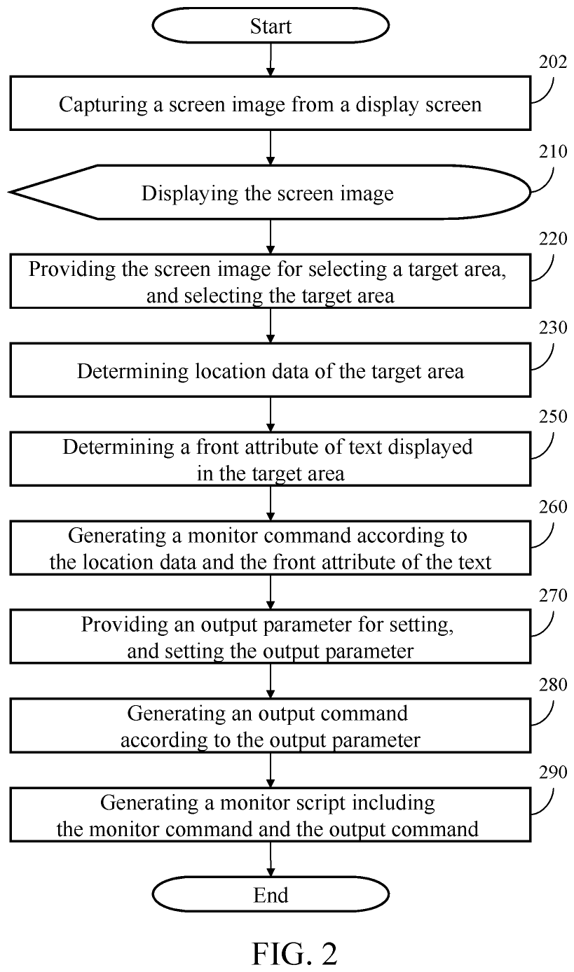

Next, an operation embodiment of the system and method of the present invention will be described with reference to FIG. 2, which is a flowchart of the method for editing a monitoring script in a screen image according to the present invention.

First, the image capturing module 110 can capture a screen image from a display screen (step 202). In this embodiment, it is assumed that the image capturing module 110 can connect to the target device to be monitored by a wired or wireless network to capture the screen image from the display screen of the target device.

After the image capturing module 110 captures the screen image, the area selecting module 120 can display the screen image captured by the image capturing module 110 (step 210), and can provide the screen image for selecting a target area and select the target area (step 220). In this embodiment, the area selecting module 120 can provide a user to operate an input device such as a mouse to double-click on the screen image displayed, and the area selecting module 120 can obtain the position where the user double clicks on the screen image after the user double-clicks, and can determine the area surrounding the double-clicked position according to the lines and/or color blocks in the screen image. The area selecting module 120 can select the determined area as the target area, and can generate the target representation data corresponding to the target area determined.

After the area selecting module 120 selects the target area from the screen image, the area selecting module 120 may determine the location data of the selected target area (step 230). In this embodiment, it is assumed that the area selecting module 120 can use the upper left corner of the window containing the target area in the screen image as the reference coordinate point, and use the upper left corner of the target area as the index coordinate point, and can calculate the relative distance between the index coordinate point and the reference coordinate point in the horizontal direction and the vertical direction, and the width and height of the target area in the screen image, thereby determining the location data of the target area.

After the area selecting module 120 selects the target area and determines the location data of the target area (steps 220 and 230), the attribute determination module 150 may determine a font attribute of the text in the target area selected by the area selecting module 120 (step 250), and the determined font attribute is displayed around the target area. In this embodiment, it is assumed that the attribute determination module 150 can extract the target image from the screen image captured by the image capturing module 110 according to the location data of the target area obtained by the area selecting module 120, and the fonts installed in the operating system that are defined as common fonts are compared with the target image that is extracted respectively. If there is a matching font in comparing, the attribute determination module 150 may further determine each font attribute of the text represented by the target image. If all the common fonts do not match the target image, the attribute determination module 150 can continue to compare the fonts that are not defined as common fonts installed in the operating system with the extracted target image. If there is a matching font in comparing, the attribute determination module 150 may further determine each font attribute of the text represented by the target image. After the attribute determination module 150 determines the font attribute, the dialog box containing the determined font attribute may be displayed at a distance from the target area, and may be provided for the user to edit the target representation data.

After the attribute determination module 150 determines the font attribute of the text in the target area selected by the area selecting module 120 (step 250), the script generation module 170 may generate a monitoring command corresponding to the target area selected by the area selecting module 120 according to the location data of the target area obtained by the area selecting module 120 and the font attribute determined by the attribute determination module 150 (step 260).

Next, the user may repeat the above steps 220 to 250 until all the target areas to be monitored are selected in the screen image by the area selection module 120.

Thereafter, the parameter setting module 160 can provide an output parameter for setting and set the output parameter (step 270). In this embodiment, it is assumed that the user can open the dialog box provided by the parameter setting module 160, and the parameter setting module 160 can obtain the target representation data corresponding to each target area, and display all the target representation data in the dialog box to provide user for choice.

After the parameter setting module 160 sets the output parameter (step 270), the script generation module 170 may generate an output command according to the output parameter set by the parameter setting module 160 (step 280). In this embodiment, assuming that the user selects all of the target representation data, the script generation module 170 can generate an output command containing all of the target representation data.

After the script generation module 170 generates the monitoring command and the output command, the script generation module 170 can generate a monitoring script including the monitoring command and the output command generated (step 290).

Thus, after the monitoring script is generated by the present invention, the monitoring script can be copied to a specific device, and the device is operated to execute the monitoring script for monitoring.

If the parameter setting module 160 sets the monitoring mode as the local monitoring, the specific device is the device to be monitored, and if the monitoring mode is set as the remote monitoring, the specific device may be any device that can be connected to the device to be monitored via IPKVM.

In addition, if the parameter setting module 160 sets the execution frequency to once, the monitoring script generated by the script generation module 170 may comprise an environment command indicating that execution is performed once, and the device that executes the monitoring script only outputs the identification result of the text of each target area once according to the environment command. If the execution frequency is set to not stop by the parameter setting module 160, the monitoring script generated by the script generation module 170 may include an environment command indicating continuous execution, and the device that executes the monitoring script can continuously identify the characters in each target area according to the environment command indicating continuous execution, and output the identification results.

In the above embodiment, before the script generation module 170 generates the monitoring script (step 290), the present invention may also provide the user to edit each command generated by the script generation module 170. In this embodiment, the user can operate the input device such as a mouse to click the monitoring command to be edited, and the area selecting module 120 can display the screen image captured by the image capturing module 110, and can mark the target area corresponding to the monitoring command in the screen image according to the location data included in the monitoring command, and may adjust the marked target area, and redetermine the location data of the adjusted target area. At the same time, the attribute determination module 150 can also display the dialog box around the marked target area, and can display the font attribute of the text in the marked target area in the dialog box, provide the displayed font for editing, and edit the font.

In summary, it can be seen that the difference between the present invention and the prior art is that capturing the screen image from the display screen of the device to be monitored; determining location data of the target area and the front attribute of text displayed in the target area after selecting the target area from the screen image; generating the monitor command included in the monitor script according to the location data and the front attribute; and providing the output parameter for setting, setting the output parameter, and generating the output command included in the monitor script according to the output parameter. By aforementioned technology means, the present invention may solve the problem in the prior art that there is a certain degree of difficulty in editing script commands that can only be done by professionals, and achieve technical efficiency in editing the script commands in a more intuitive manner.

Furthermore, the method for editing the monitoring script in the screen image of the present invention may be implemented by hardware, software or a combination thereof, and may be implemented by centralized computer system or different devices distributed in interconnected computer systems.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method for editing a monitor script in a screen image, comprising:
capturing the screen image from a display screen;
displaying the screen image, providing the screen image for selecting a target area, and selecting the target area;
determining location data of the target area;
determining a font attribute of text displayed on the target area;
generating a monitor command according to the location data and the font attribute of the text;
providing an output parameter for setting, setting the output parameter, and generating an output command according to the output parameter; and
generating the monitor script including the monitor command and the output command.

2. The method according to claim 1, wherein before the step of providing the screen image for selecting the target area and selecting the target area, the method further comprising:
providing a monitor mode and/or an execution frequency for setting, setting the monitor mode and/or the execution frequency, and generating an environmental command corresponding thereto.

3. The method according to claim 1, wherein before the step of generating the monitor script including the monitor command and the output command, the method further comprising:
displaying the screen image and the font attribute; and marking the target area in the screen image according to the location data;
providing the font attribute for editing and/or the target area for adjusting, and editing the font attribute and/or adjusting the target area; and
redetermining the location data of the target area adjusted.

4. The method according to claim 1, wherein the step of providing the output parameter for setting, and setting the output parameter further comprises:
providing an output item corresponding to the target area for selecting and selecting the output item.

5. The method according to claim 1, wherein the step of determining the location data of the target area is to determine the relative positions of an index coordinate point and a reference coordinate point of the target area.

6. A system for editing a monitor script in a screen image; comprising:
an image capturing module; configured to capture the screen image from a display screen;
an area selecting module, configured to display the screen image; provide the screen image for selecting a target area, and select the target area in the screen image;
an attribute determination module, configured to determine location data of the target area and determine a font attribute of text displayed on the target area;
a parameter setting module, configured to provide an output parameter for setting, and set the output parameter; and
a script generation module, configured to generate a monitoring command according to the font attribute and the location data, and generate an output command according to the output parameter, and generate a monitoring script including the monitoring command and the output command.

7. The system according to claim 6, wherein the parameter setting module is further configured to provide a monitor mode and/or an execution frequency for setting and set the monitor mode and/or the execution frequency, and the script generation module is further configured to generate at least one environmental command according to the monitor mode and/or the execution frequency and generate the monitor script including the at least one environmental command.

8. The system according to claim 6, wherein the attribute determination module is further configured to display the font attribute, provide the font attribute for editing, and edit the font attribute, and the area selecting module is further configured to display the screen image, mark the target area in the screen image according to the location data, adjust the target area, and redetermine the location data of the target area adjusted.

9. The system according to claim 6, wherein the parameter setting module provides an output item corresponding to the target area for selecting and select the output item to set the output parameter.

10. The system according to claim 6, wherein the area selecting module determines the relative positions of an index coordinate point and a reference coordinate point of the target area to generate the location data.
